(19) United States
(12) Patent Application Publication
(10) Pub. No.: US 2016/0203447 A1
(43) Pub. Date: Jul. 14, 2016

(54) ELECTRONIC PLATFORM FOR REMOVAL OF INFORMATION FROM AN AUTOMATED CLEARING HOUSE ("ACH") ADDENDA RECORD

(71) Applicant: Bank of America Corporation, Charlotte, NC (US)

(72) Inventors: Michelle D. Nichols, Rock Hill, SC (US); Patricia Rudek, Rochester, NY (US); Mary E. Arensman, Dallas, TX (US)

(21) Appl. No.: 14/594,211

(22) Filed: Jan. 12, 2015

(51) Int. Cl. G06Q 20/02; G06Q 30/00

(52) U.S. Cl. CPC G06Q 20/023; G06Q 30/018

(57) ABSTRACT

An apparatus for removal of information from an Automated Clearing House (“ACH”) addenda record is provided. The apparatus may include a receiver configured to receive ACH information and ACH addenda information associated with the ACH information. In some embodiments, the apparatus may analyze the ACH addenda information, flag at least one field from the ACH addenda information as sensitive information, remove the field comprising sensitive information from the ACH addenda information, identify remaining ACH addenda information; and crop a subset of the remaining ACH addenda information to harvest a portion of the remaining information. The portion may include core fields. The apparatus may also transmit the harvested information for further display, transmission or export.

### FIELD OF TECHNOLOGY

This application relates to transactions involving ACH addenda records.

### BACKROUND OF THE DISCLOSURE

An ACH transmission typically includes a certain amount of information. The transmission itself includes a portion of the information and an ACH addenda, preferably associated with the transmission, includes additional information.

Some of the information incorporated in the ACH transmission may be confidential information. Some of the information included in the ACH transmission may be non-confidential information.

While it may be important to disclose some of the information to relevant, and authorized parties, nevertheless certain rules and regulations may require that at least a portion of the information remain confidential. Such rules and regulations may include privacy rules and regulations that prevent disclosure of certain personal information. For example, to the extent that financial institutions provide clearinghouse services to health care businesses, the financial institutions may be covered by the Health Insurance Portability and Accountability Act (“HIPPA”).

### SUMMARY OF THE INVENTION

Methods and systems for removal of information from an Automated Clearing House (“ACH”) addenda record are provided. One such method may include receiving ACH information and receiving ACH addenda information associated with the ACH information. The method may further include analyzing the ACH addenda information. The analysis may result in flagging at least one field from the ACH addenda information as sensitive information. The method may further include removing the field comprising sensitive information from the ACH addenda information and identifying remaining ACH addenda information. The method may then include cropping a subset of the remaining ACH addenda information to harvest a portion of the remaining information. The portion may include core fields. The harvested information may be displayed, transmitted or exported to provide a response to a client inquiry or for any other suitable purpose.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative apparatus in accordance with principles of the invention;

FIG. 2 shows an illustrative apparatus in accordance with the principles of the invention;

FIG. 3 shows an illustrative flow diagram according to certain embodiments; and

FIG. 4 shows another illustrative flow diagram in accordance with the principles of the invention.

### DETAILED DESCRIPTION OF THE DISCLOSURE

Apparatus, methods and media (collectively referred to herein as a “system”) for removal of information from an Automated Clearing House (“ACH”) addenda record are provided.

For the sake of illustration, the invention will be described as being performed by a “system.” The “system” may include one or more of the features of the apparatus and methods that are shown or described herein and/or any other suitable device or approach. The “system” may be provided by an entity. The entity may be an individual, an organization or any other suitable entity.

The system may receive information. The information may include ACH information.

The system may receive addenda information. The addenda information may be ACH addenda information. The ACH addenda information may be associated with the ACH information.

The addenda information may be recorded in a record that includes a suitable number of characters. In some embodiments, a suitable number of characters may be 80 characters.

In certain embodiments, the system may flag a field. The field may be a field from the ACH addenda information. The field may be flagged as sensitive information. The field may be flagged as containing sensitive information.

The system may remove the field. The system may remove the field containing sensitive information. The system may remove the sensitive information. The field and/or sensitive information may be removed from the ACH addenda information.

The system may identify remaining information. The remaining information may include remaining ACH addenda information.

The system may crop information. The cropping may include removing one or more fields from a data set. The system may crop a subset of remaining ACH addenda information. The subset of information may be cropped to harvest a portion of information. The portion of information may include a portion of the remaining information.

The portion of remaining information may include core fields. Such core fields may include invoice number, date and amount of ACH transmission or a subset of the transmission. In certain embodiments, such transmissions may only show certain information in code form. For example, certain information such as client names may be encoded.

The system may transmit the harvested information. The harvested information may be transmitted for further ACH processing. In certain embodiments, the harvested information may be transmitted to ACX, which is the United States ACH processing platform. Some embodiments may also apply to international transmissions processed through SWIFT.

In response to a client request for information regarding the ACH, certain embodiments may enable only predetermined information to be transmitted.

The removed ACH field may be stored in memory. The memory may include computer memory.

The identified remaining ACH addenda information may include non-sensitive ACH information. The remaining ACH addenda information may include non-sensitive ACH addenda fields.

The harvested portion of information may be a first portion. The first portion may include a first portion of the remaining information. The first portion of information may be transmitted for further ACH processing or to respond to a client inquiry. The harvested portion of information may be a second portion. The second portion may include a second portion of remaining information. The second portion of information may not be transmitted for further ACH processing.

The system may flag at least one field. The field may be flagged for containing sensitive information. The field may be flagged as containing sensitive information. The field may be flagged using an algorithm. The algorithm may include a selection algorithm. The algorithm may be a pre-configured algorithm. In some embodiments, the algorithm could determine sensitive information based on criteria such as SEC code and/or source of transmission (originator/receiver or region/country). The algorithm could also apply to both memo (soft-posted) and hard-posted transactions.

Such an algorithm may determine which fields are sensitive based on the nature of the characters in the field. For example, certain algorithms may determine whether an account number appears in the addenda. Such an algorithm may review the addenda to determine whether eight numbers appear in a row between the beginning and the end of a field. Similarly, an algorithm may review the addenda to determine whether, in the case of a social security number determination, nine numbers appear between the beginning and the end of a field. Such algorithms may preferably be used to identify confidential information appearing in fields.

In certain embodiments, upon a determination that a field contains confidential and/or sensitive information, the field containing sensitive information may be removed. The field containing sensitive information may be flagged for removal. The field that is flagged for removal may be removed. The system may remove the field to satisfy one or more rules. The one or more rules may include laws, by-laws or compliance rules. Such rules may include, for example, HIPPA rules.

The ACH addenda field may be one of a plurality of ACH addenda fields.

The plurality of ACH addenda fields may include an invoice number, date, amount, entry detail record, file header record, batch header record, batch control, total, priority code, origin, destination, account number or any other suitable ACH addenda field.

The system may remove the ACH addenda field containing sensitive information from the ACH addenda information. The removed field containing sensitive information may be prevented from further display, transmission or export.

In certain embodiments, following removal of the field(s) containing sensitive information, the addenda may be cropped down. The cropping down may preferably show what looks like a complete addenda, but, in fact only shows non-sensitive information.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

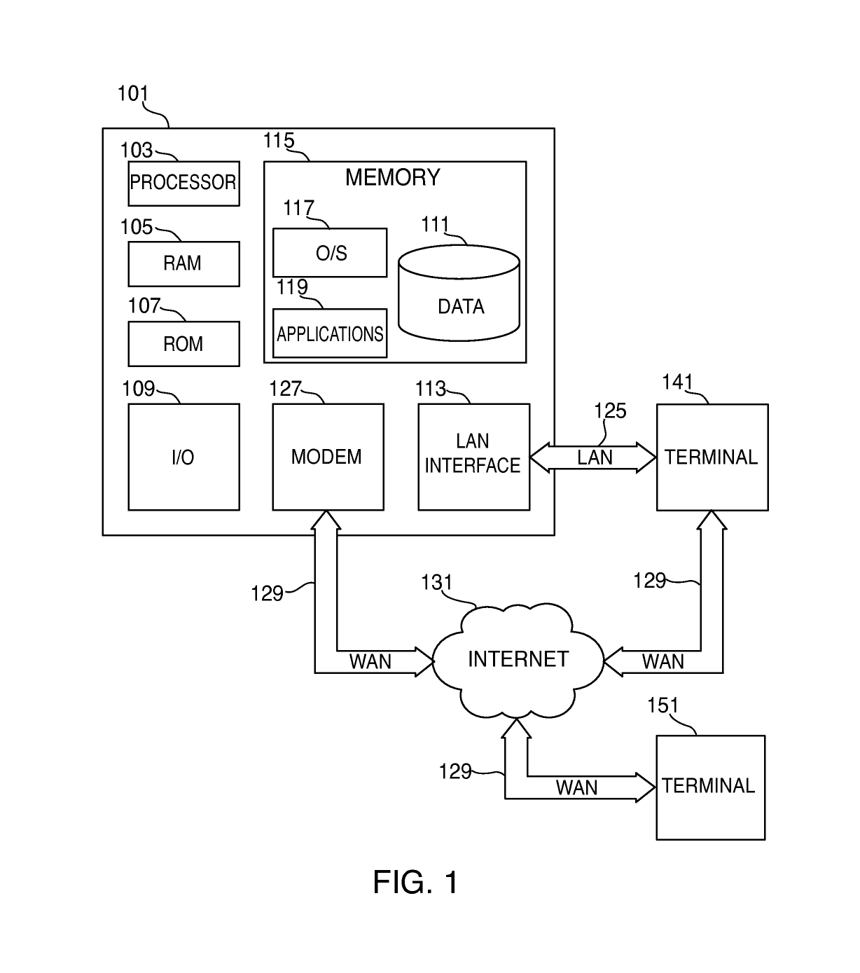

FIG. 1 is an illustrative block diagram of system 100 based on a computer 101. The computer 101 may have a processor 103 for controlling the operation of the device and its associated components, and may include RAM 105, ROM 107, input/output module 109, and a memory 115. The processor 103 will also execute all software running on the computer—e.g., the operating system. Other components commonly used for computers such as EEPROM or Flash memory or any other suitable components may also be part of the computer 101.

The memory 115 may be comprised of any suitable permanent storage technology—e.g., a hard drive. The memory 115 stores software including the operating system 117 any application(s) 119 along with any data 111 needed for the operation of the system 100. Alternatively, some or all of computer executable instructions may be embodied in hardware or firmware (not shown). The computer 101 executes the instructions embodied by the software to perform various functions.

Input/output (“I/O”) module may include connectivity to a microphone, keyboard, touch screen, and/or stylus through which a user of computer 101 may provide input, and may also include one or more speakers for providing audio output and a video display device for providing textual, audiovisual and/or graphical output.

System 100 may be connected to other systems via a LAN interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program(s) 119, which may be used by computer 101, may include computer executable instructions for invoking user functionality related to communication, such as email, Short Message Service (SMS), and voice input and speech recognition applications.

Computer 101 and/or terminals 141 or 151 may also be devices including various other components, such as a battery, speaker, and antennas (not shown).

Terminal 151 and/or terminal 141 may be portable devices such as a laptop, cell phone, Blackberry™, or any other suitable device for storing, transmitting and/or transporting relevant information. Terminals 151 and/or terminal 141 may be other devices. These devices may be identical to system 100 or different. The differences may be related to hardware components and/or software components.

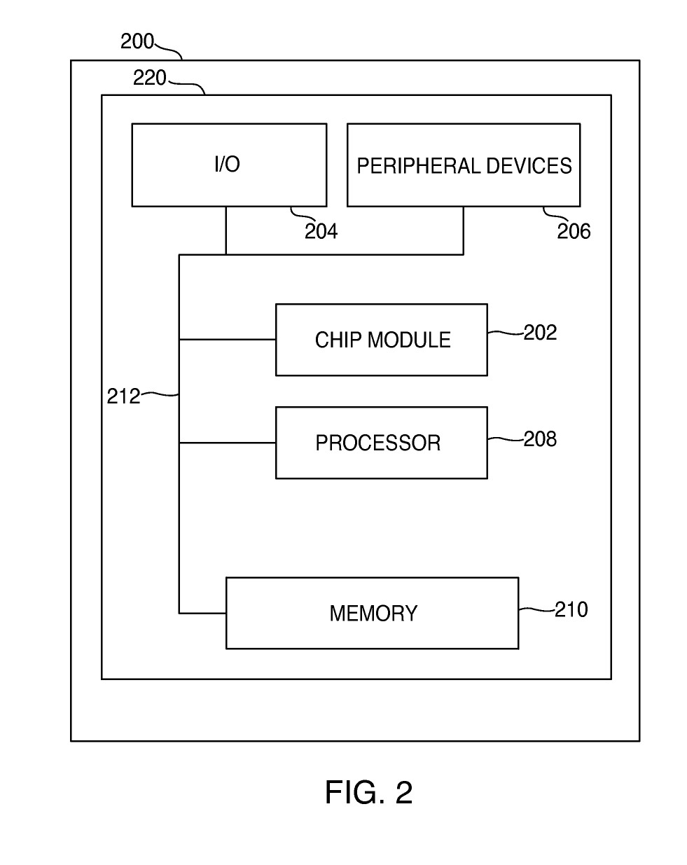

FIG. 2 shows illustrative apparatus 200. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device 208, which may compute data structural information, structural parameters of the data and/or field locations determinants and/or contents and machine-readable memory 210.

Machine-readable memory 210 may be configured to store in machine-readable data structures: information pertaining to a ACH addenda, information pertaining to classification of confidential information, updated rules and regulations, current transactions and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

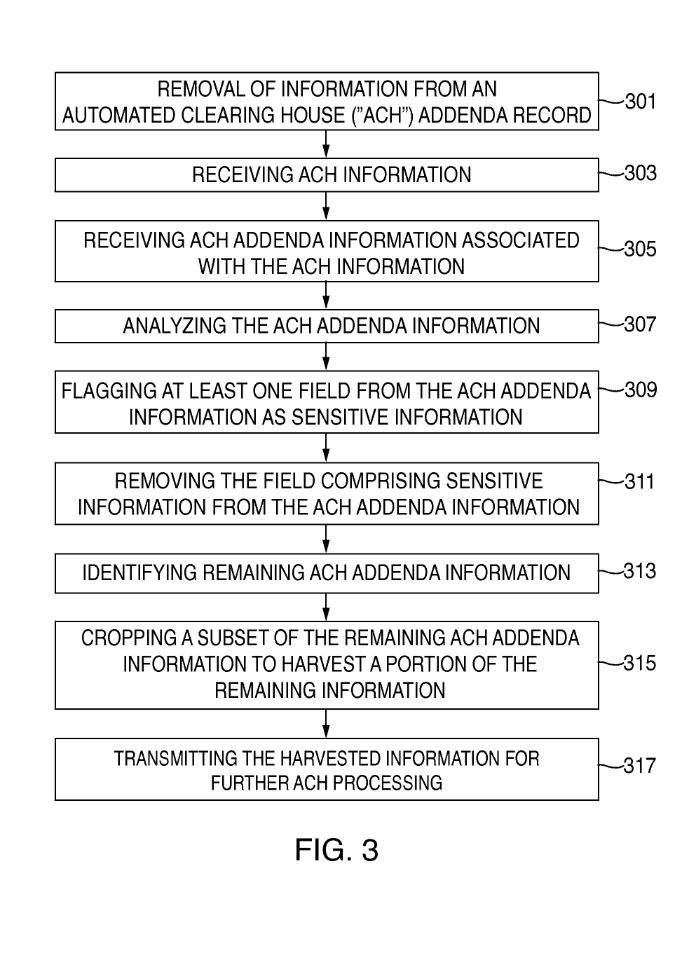

FIG. 3 shows illustrative process 301 for removal of information from an Automated Clearing House (“ACH”) addenda record. Step 303 shows receiving ACH information. Preferably, step 305 shows receiving ACH addenda information associated with the ACH information.

Step 307 shows analyzing the ACH addenda information. Preferably pursuant to the analysis, step 309 shows flagging at least one field from the ACH addenda information as sensitive information.

Step 311 shows removing the field comprising sensitive information from the ACH addenda information. Step 313 shows identifying remaining ACH addenda information.

The method may then, as shown in step 315, crop a subset of the remaining ACH addenda information to harvest a portion of the remaining information. The portion may preferably include core fields.

Once the core fields have been prepared, the method may include transmitting the harvested information for further ACH processing. In one embodiment, transmitting the harvested information may include transmitting the cropped addenda.

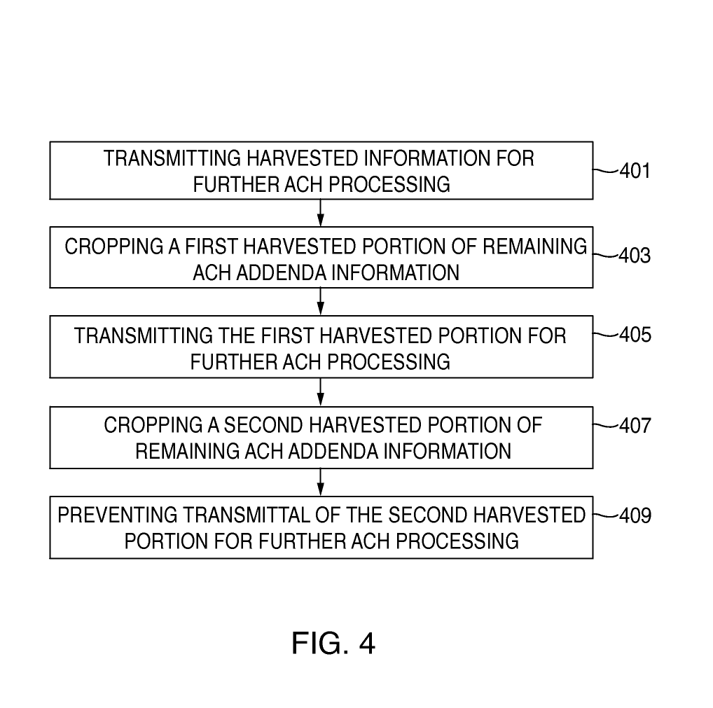

FIG. 4 shows a process 401 for transmitting harvested information for further ACH processing. The process may include cropping a first harvested portion of remaining ACH addenda information, as shown in step 403.

The process may also include step 407 which illustrates cropping a second harvested portion of the remaining ACH addenda information. The remaining ACH addenda information preferably remains for display, transmission or export.

Step 409 shows preventing transmittal of the second harvested portion for further use. The preventing may be based, for example, on security concerns associated with client or employee visibility with respect to the second harvested portion of the ACH addenda information.

Thus, methods and apparatus for removal of information from an automated clearing house (“ACH”) addenda record are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for removal of information from an Automated Clearing House (“ACH”) addenda record, the method comprising:
receiving ACH information;
receiving ACH addenda information associated with the ACH information;
analyzing the ACH addenda information;
flagging at least one field from the ACH addenda information as sensitive information;
removing the field comprising sensitive information from the ACH addenda information;
identifying remaining ACH addenda information;
cropping a subset of the remaining ACH addenda information to harvest a portion of the remaining information, wherein the portion comprises core fields; and
transmitting the harvested information for display, transmission or export.

2. The method of claim 1 wherein the removed ACH field is stored in computer memory.

3. The method of claim 1 wherein the identified remaining ACH addenda information comprises non-sensitive ACH addenda fields.

4. The method of claim 1 wherein when the harvested portion is a first portion of the remaining information, the method further comprises a second portion, said second portion not being transmitted for display or export.

5. The method of claim 1 wherein the at least one field is flagged as sensitive information using a pre-configured selection algorithm, said selection algorithm being based on at least one of a Securities Exchange Commission code and source of transmission.

6. The method of claim 1 wherein the field comprising sensitive information is removed to comply with compliance rules and regulations.

7. The method of claim 1 wherein the at least one ACH addenda field is one of a plurality of ACH addenda fields.

8. The method of claim 7 wherein the plurality of ACH addenda fields are selected from a group consisting of:
invoice number;
date;
amount;
entry detail record;
file header record;
batch header record;
batch control total;
priority code;
origin; and
destination.

9. The method of claim 1 wherein the removed field comprising sensitive information from the ACH addenda information is prevented from further display, transmission or export.

10. An apparatus for removal of information from an Automated Clearing House (“ACH”) addenda record, the apparatus comprising:
a receiver configured to receive:
ACH information; and
ACH addenda information associated with the ACH information;
a processor configured to:
analyze the ACH addenda information;
flag at least one field from the ACH addenda information as sensitive information;
remove the field comprising sensitive information from the ACH addenda information;
identify remaining ACH addenda information; and
crop a subset of the remaining ACH addenda information to harvest a portion of the remaining information, wherein the portion comprises core fields; and
a transmitter configured to transmit the harvested information for further display, transmission or export.

11. The apparatus of claim 10 wherein the removed ACH field is stored in computer memory.

12. The apparatus of claim 10 wherein the identified remaining ACH addenda information comprises non-sensitive ACH addenda fields.

13. The apparatus of claim 10 wherein when the harvested portion is a first portion of the remaining information, the apparatus further comprises a second portion.

14. The apparatus of claim 10 wherein the at least one field is flagged as sensitive information using a pre-configured selection algorithm, said selection algorithm being based on at least one of a Securities Exchange Commission code and source of transmission.

15. The apparatus of claim 10 wherein the field comprising sensitive information is removed to comply with compliance rules.

16. The apparatus of claim 10 wherein the at least one ACH addenda field is one of a plurality of ACH addenda fields.

17. The apparatus of claim 16 wherein the plurality of ACH addenda fields are selected from a group consisting of:
invoice number;
date;
amount;
entry detail record;
file header record;
batch header record;
batch control total;
priority code;
origin; and
destination.

18. The apparatus of claim 10 wherein the removed field comprising sensitive information from the ACH addenda information is prevented from further display, transmission or export.

19. The apparatus of claim 10 wherein the ACH addenda information is not more than 80 characters.
